(19) United States
(12) Patent Application Publication
(10) Pub. No.: US 2022/0095875 A1
(43) Pub. Date: Mar. 31, 2022

(54) Docking Station and Cleaning System

(71) Applicant: SHENZHEN FLY RODENT DYNAMICS INTELLIGENT TECHNOLOGY CO., LTD., Shenzhen (CN)

(72) Inventors: Xiao HU, Shenzhen (CN); Changtai XIA, Shenzhen (CN)

(21) Appl. No.: 17/166,137

(22) Filed: Feb. 3, 2021

(30) Foreign Application Priority Data
Sep. 30, 2020 (CN) 202011066370.7

(51) Int. Cl. A47L 11/40; A46B 17/06; A47L 11/24; A46B 9/02; H02J 7/00

(52) U.S. Cl. CPC A47L 11/4091; A47L 11/4005; A47L 11/4041; A46B 17/06; A46B 2200/30; A46B 9/026; H02J 7/0044; A47L 2201/022; A47L 2201/028; A47L 11/24

(57) ABSTRACT

A docking station includes a tray and a charging stand. The tray is provided with a cleaning structure configured for self-cleaning of a roller brush of the cleaning robot. The charging stand is detachably mounted to the tray. The above arrangement enables self-cleaning of a cleaning robot and improves user experience, with a simple structure and low cost.

### CROSS-REFERENCE TO RELATED APPLICATION

The present disclosure claims priority of Chinese patent application with the filing number 202011066370.7 filed on Sep. 30, 2020 with the Chinese Patent Office, and entitled “Docking Station and Cleaning System”, the contents of which are incorporated herein by reference in entirety.

### TECHNICAL FIELD

The present disclosure relates to the technical field of cleaning devices, and in particular to a docking station and a cleaning system.

### BACKGROUND ART

Cleaning robots are household robots that serve humans. The cleaning robots mainly carry out household hygiene tasks such as cleaning and washing. They can automatically complete floor cleaning tasks with certain artificial intelligence.

With the widespread use of intelligent household appliances, cleaning robots are popular among consumers because of their high practicability. Cleaning robots are usually equipped with a roller brush for cleaning floors. After a cleaning robot has operated for a long time, a certain amount of dirt is accumulated on its roller brush, whereby the cleaning effect of the cleaning robot will be reduced. in this case, the user needs to wash the roller brush by himself or herself. This increases the labor burden on users and may cause unpleasant life experience to users.

### SUMMARY

One aspect of the present disclosure provides a docking station, applicable to a cleaning robot to be docked, which comprises: a tray, provided with a cleaning structure, wherein the cleaning structure is configured for self-cleaning of a roller brush of the cleaning robot; and a charging stand, detachably mounted to the tray.

Another aspect of the present disclosure provides a cleaning system that comprises a cleaning robot and a docking station. The docking station comprises: a tray, provided with a cleaning structure, wherein the cleaning structure is configured for self-cleaning of a roller brush of the cleaning robot; and a charging stand, detachably mounted to the tray. The roller brush of the cleaning robot is at least partially located in the cleaning structure, when the cleaning robot is docked at the docking station.

### BRIEF DESCRIPTION OF THE DRAWINGS

One or more embodiments are exemplarily described with reference to figures in the corresponding accompanying drawings. These exemplary descriptions are not intended to limit the embodiments. Elements marked with the same reference numerals in the drawings are represented as similar elements. The figures in the accompanying drawings do not constitute a scale limitation unless otherwise stated particularly.

FIG. 1 is a perspective structural view of a docking station according to one of the embodiments of the present disclosure;

FIG. 2 is an exploded schematic view of the docking station in FIG. 1;

FIG. 3 is a perspective structural view of a roller brush receptacle of the docking station in FIG. 1;

FIG. 4 is a perspective structural view of a mounting stand of a tray of the docking station in FIG. 3;

FIG. 5 is a perspective structural view of a charging stand of the docking station in FIG. 1;

FIG. 6 is an exploded schematic view of the charging stand in FIG. 5;

FIG. 7 is a schematic structural view of some components of the charging stand in FIG. 6; and

FIG. 8 is a schematic structural view of a cleaning robot of a cleaning system according to one of the embodiments of the present disclosure.

### DETAILED DESCRIPTION OF THE EMBODIMENTS

The present disclosure will be described in more detail below with reference to the accompanying drawings and specific embodiments, in order to facilitate the understanding of the present disclosure. It should be noted that, when an element is described to be “fixed”/“mounted” to another element, it may be directly on the other element, or there may be one or more intervening elements therebetween. When an element is described to be “connected” to another element, it may be directly connected to the other element, or there may be one or more intervening elements therebetween. As used herein, the terms such as “up”, “down”, “inside”, “outside”, “vertical”, and “horizontal” indicate the orientation or positional relationships shown based on the figures, and these terms are intended only to facilitate the description of the present disclosure and simplify the description, but not intended to indicate or imply that the referred devices or elements must be in a particular orientation or constructed or operated in the particular orientation, and therefore should not be construed as limiting the present disclosure. In addition, terms such as “first” and “second” are used for descriptive purposes only, and should not be understood as an indication or implication of relative importance.

Unless otherwise defined, all technical and scientific terms used herein have the same meanings as those commonly understood by those skilled in the technical field to which the present disclosure pertains. The terms used in the description of the present disclosure are intended for the purpose of describing specific embodiments only and are not intended to limit the present disclosure. As used herein, the term “and/or” includes any and all combinations of one or more of the associated listed items.

In addition, the technical features involved in different embodiments of the present disclosure described below can be combined with each other if they do not conflict with each other.

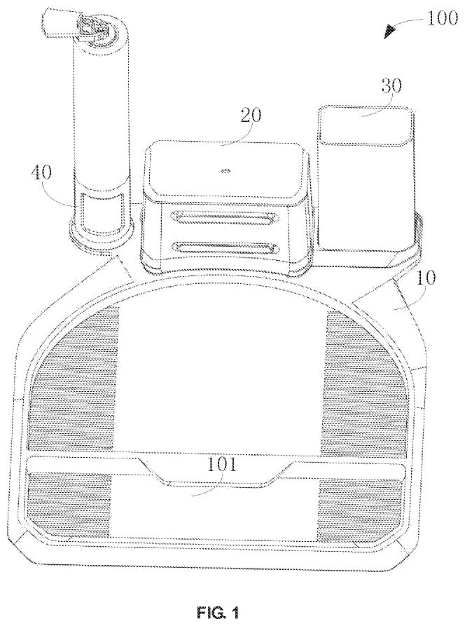

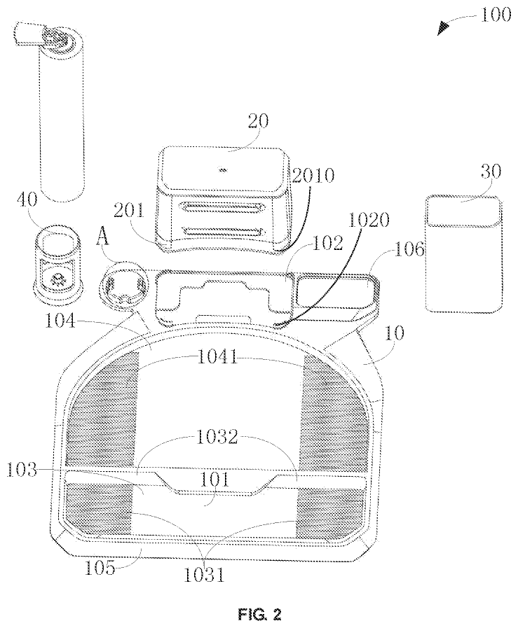

Referring to FIGS. 1 and 2, FIG. 1 is a perspective structure view of a docking station according to an embodiment of the present disclosure, and FIG. 2 is an exploded structural view of the docking station of FIG. 1. The docking station 100 is for use with a cleaning robot and configured to enable self-cleaning of the cleaning robot. The docking station 100 includes a tray 10 and a charging stand 20. The tray 10 is provided with a cleaning structure 101. The cleaning structure 101 is configured for self-cleaning of a roller brush of the cleaning robot. The charging stand 20 is detachably mounted to the tray 10. The charging stand 20 is configured to charge the cleaning robot. Here, when the cleaning robot is docked at the docking station 100, the cleaning robot can be self-cleaned on the one hand and can be charged on the other hand, thereby reducing the labor burden on a user and improving the user experience with a simple structure and low cost.

Regarding the tray 10 described above, the bottom of the tray 10 is arranged in a form of a horizontal plane, and the tray 10 may be placed on a floor. The cleaning robot may move along the edge of the tray 10 to a surface of the tray 10 facing away from the floor and be self-cleaned and charged by the cleaning structure 101 and the charging stand 20, respectively. The cleaning robot may be wholly supported on the tray 10, or the cleaning robot may be partially supported on the tray 10, wherein the roller brush of the cleaning robot is at least partially received in the cleaning groove.

In this embodiment, the cleaning structure 101 is a cleaning groove. The cleaning groove is configured to receive at least part of the roller brush. The roller brush rotates in the cleaning groove so as to be self-cleaned. In a specific implementation process, cleaning water flowing out from the roller brush of the cleaning robot is contained in the cleaning groove, or cleaning water is poured into the cleaning groove. At least part of the roller brush of the cleaning robot is immersed in the cleaning water in the cleaning groove, and the roller brush is rotated so that dirt adhering to the roller brush falls into the cleaning water, thereby achieving the self-cleaning operation of the cleaning robot. After the self-cleaning operation is completed, dirty water in the cleaning groove can be recovered and stored into a dirty water tank of the cleaning robot, which facilitates the centralized treatment of dirty water by the user. It is unnecessary for the user to dispose of dirty water in the cleaning groove after every time the cleaning robot is self-cleaned in the cleaning groove.

In some other embodiments, the cleaning structure 101 may be another structure for enabling self-cleaning of the cleaning robot. For example, the cleaning structure 101 is a scraper (not shown). The scraper is in the shape of an elongated plate as a whole. The scraper includes a fixed portion and a scraping portion fixed to the fixed portion. The fixed portion is fixed to the tray 10. The scraping portion is provided with serrations. The serrations are configured to reach into the surface of the roller brush of the cleaning robot, and the roller brush rotates so that dirt adhering to the roller brush drops down, thereby achieving the self-cleaning operation of the cleaning robot.

It will be understood that, in some other embodiments, the cleaning structure 101 includes both the cleaning groove and the scraper described above, and the scraper is arranged in the cleaning groove. On the one hand, the cleaning groove can achieve the effect of washing the roller brush of the cleaning robot with water. On the other hand, the scraper can achieve the effect of “dry-cleaning” the roller brush of the cleaning robot. The self-cleaning effect of the cleaning robot can be further improved by combining the cleaning groove with the scraper.

Referring to FIG. 2, the tray 10 is provided sequentially with a socket portion 102, a second groove 104, and a first groove 103. The second groove 104 is located between the socket portion 102 and the first groove 103. The socket portion 102 is configured to allow the charging stand 20 to be mounted thereon. The above-mentioned cleaning groove is arranged in the first groove 103. The second groove 104 is configured to support part of the cleaning robot. When the cleaning robot is wholly supported on the tray 10, the roller brush of the cleaning robot is at least partially received in the first groove 103, and a charging pole piece of the cleaning robot is connected to the charging stand 20.

In order to avoid slipping of the cleaning robot when moving along the surface of the tray 10, first anti-slip patterns 1031 are arranged on both sides of the bottom of the above first groove 103, the cleaning groove is located between the two first anti-slip patterns 1031, and second anti-slip patterns 1041 are arranged on both sides of the bottom of the second groove 104. The first anti-slip pattern 1031 and the second anti-slip pattern 1041 on the same side are arranged opposite to each other. The travelling wheels (left and right wheels) on both sides of the bottom of the cleaning robot may move along the two first anti-slip patterns 1031 to the two second anti-slip patterns 1041, respectively, thereby preventing slipping of the cleaning robot when moving along the surface of the tray 10. Moreover, the second anti-slip patterns 1041 are arranged to help the cleaning robot to be stably supported on the tray 10. It should be noted that the cleaning groove may be formed by recessing the bottom of the first groove 103. In other words, the bottom of the first groove 103 on which the first anti-slip patterns 1031 are formed is higher than the cleaning groove. Alternatively, the cleaning groove may be formed by the entire bottom of the first groove 103. In other words, the bottom of the first groove 103 has a lower middle portion and two higher side portions on which the first anti-slip patterns 1031 are formed, so that a recess gradually extending downward from the two sides to the middle is formed.

Referring to FIG. 2, from another perspective, the tray 10 comprises a plurality of first raised features arranged on the bottom of the first groove 103. The plurality of first raised features comprise a first left part arranged on the left side of the bottom of the first groove 103 and a first right part arranged on the right side of the bottom of the first groove 103. The first left part refers to the first anti-slip patterns 1031 on the left side and the first right part refers to the first anti-slip patterns 1031 on the right side. Each first raised feature is elongated convex structure still functioning as a supporting element to support a cleaning element of the cleaning robot when the cleaning element is at least partially received in the cleaning groove.

And the tray 10 further comprises a plurality of second raised features arranged on the bottom of the second groove 104. The plurality of second raised features comprise a second left part arranged on the left side of the bottom of the second groove 104 and a second right part arranged on the right side of the bottom of the second groove 104. The second left part refers to the second anti-slip patterns 1041 on the left side and the second right part refers to the second anti-slip patterns 1041 on the right side. Thereby the first left part is corresponding to the second left part, and the first right part is corresponding to the second right part.

A first inclined surface 1032 is provided between the first groove 103 and the second groove 104, in order to facilitate the movement of the travelling wheels of the cleaning robot from the first groove 103 to the second groove 104 and to prevent the travelling wheels of the cleaning robot from getting stuck in the first groove 103. Specifically, a connecting wall is formed between the first groove 103 and the second groove 104. The connecting wall is provided with first inclined surfaces 1032 located on both sides of a side surface of the first groove 103. The first inclined surfaces are inclined upwardly in a direction from the first groove 103 to the second groove 104. In other words, the first groove 103 is provided with first inclined surfaces 1032, and the two first inclined surfaces 1032 are provided on the two sides of a side wall of the first groove 103 close to the second groove 104, respectively, The travelling wheels of the cleaning robot can be moved smoothly from the bottom of the first groove 103 to the second groove 104 through the first inclined surfaces 1032.

Here, each of the first inclined surfaces 1032 is located between the first anti-slip pattern 1031 and the second anti-slip pattern 1041 on the same side to join the first anti-slip pattern 1031 and the second anti-slip pattern 1041 on the same side. In other words, each of the two travelling wheels of the cleaning robot travels along the first anti-slip pattern 1031 on a respective side, enters the second groove 104 through the first inclined surface 1032, and then travels along the second anti-slip pattern 1041 to a suitable position.

Further, the first groove 103 has an outer wall remote from the second groove 104, and the outer wall has an outer side surface inclined upwardly in the direction from the first groove 103 to the second groove 104, in order to facilitate the movement of the traveling wheels of the cleaning robot from the edge of the tray 10 to the first groove 103 and to prevent the travelling wheels of the cleaning robot from being stuck on the edge of the tray 10 and unable to be wholly supported on the tray 10. In other words, the edge of the tray 10 is provided with a second inclined surface (outer side surface) 105. The second inclined surface 105 is farther away from the second groove 104 than the first groove 103. Namely, the socket portion 102, the second groove 104, the first inclined surfaces 1032, the first groove 103, and the second inclined surface 105 are arranged in sequence. The second inclined surface 105 is inclined upwardly in the direction from the first groove 103 to the second groove 104, so that the travelling wheels of the cleaning robot can be moved smoothly from the floor to the first groove 103 through the second inclined surface 105.

Regarding the charging stand 20 described above, the charging stand 20 is provided with an insert portion 201. The tray 10 is provided with a socket portion 102, and the socket portion 102 is arranged in a recessed manner. The insert portion 201 fits with the socket portion 102. The insert portion 201 is inserted into the socket portion 102, and the inner side wall of the socket portion 102 can abut against the outer side wall of the insert portion 201. The inner side wall of the socket portion 102 disables the charging stand 20 from moving in a direction parallel to the bottom wall of the socket portion 102. The charging stand 20 can be detached from the socket portion 102 in a direction perpendicular to the bottom wall of the socket portion 102, so that the charging stand 20 can be detachably mounted to the tray 10.

Further, the socket portion 102 is provided with at least two locking portions 1020 at its edge close to the cleaning structure. The insert portion 201 has an edge provided with a flange portion 2010. The at least two locking portions 1020 are locked to the flange portion 2010 to restrict an upward movement of one side of the charging stand 20 close to the cleaning structure, but the other side of the charging stand 20 can move upward. It should be noted that the flange portion 2010 may be a protruding strip along a side edge of the insert portion 201 or a plurality of protruding blocks corresponding to at least two locking portions 1020.

The docking station 100 of the embodiment of the present disclosure further includes a liquid adding measuring cup 30. The liquid adding measuring cup 30 is detachably mounted to the tray 10. The liquid adding measuring cup 30 is configured to contain a cleaning liquid which is to be added to an inner container of the cleaning robot. During self-cleaning of the cleaning robot, the cleaning liquid is released from the inner container of the cleaning robot to the roller brush. Specifically, the docking station 100 is provided with a mounting groove 106. The mounting groove 106 fits with the bottom of the liquid adding measuring cup 30. The bottom of the liquid adding measuring cup 30 is inserted into the mounting groove 106, and the inner side wall of the mounting groove 106 can abut against the outer side wall of the liquid adding measuring cup 30. The inner side wall of the mounting groove 106 disables the liquid adding measuring cup 30 from moving in a direction parallel to the bottom of the mounting groove 106. The liquid adding measuring cup 30 can be to detached from the mounting groove 106 in a direction perpendicular to the bottom of the mounting groove 106, so that the liquid adding measuring cup 30 can be detachably mounted to the tray 10.

The docking station 100 of the embodiment of the present disclosure further includes a roller brush receptacle 40. The roller brush receptacle 40 is detachably mounted to the tray 10. The roller brush receptacle 40 is configured to allow the roller brush of the cleaning robot to be inserted therein. The user may place the cleaned roller brush in the roller brush receptacle 40 to let it dry, or may place a spare roller brush in the roller brush receptacle 40.

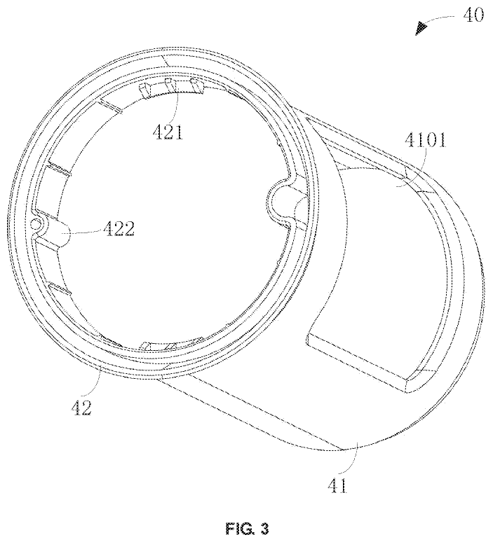

Referring to FIG. 2 in combination with FIG. 3, FIG. 3 is a perspective structural view of the roller brush receptacle. The roller brush receptacle 40 includes a cylindrical body 41 and a mounting base 42 fixedly connected to the cylindrical body 41. The cylindrical body 41 has a side wall provided with an opening 4101. A part of the roller brush is inserted into the cylindrical body 41. The opening 4101 is configured to expose the part of the roller brush inserted into the cylindrical body 41, to allow drying of the part of the roller brush inserted into the cylindrical body 41 and to prevent the part of the roller brush inserted into the cylindrical body 41 from being in a wet state for a long time. The mounting base 42 is detachably mounted to the tray 10.

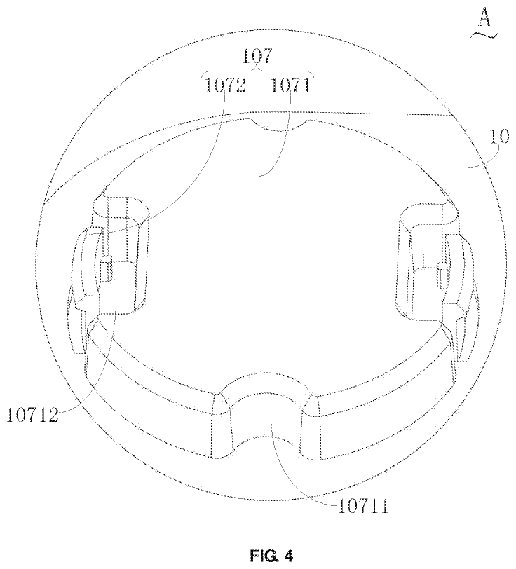

With also reference to FIG. 4, the tray 10 is provided with a mounting stand 107. The mounting stand 107 includes a fixing base 1071 and buckles 1072.

The fixing base 1071 is substantially in the shape of a round pie. The fixing base 1071 and the buckles 1072 extend from a surface of the tray 10 facing away from the floor toward a direction away from the tray 10, respectively. The fixing base 1071 is provided with positioning grooves 10711 and buckle grooves 10712. The two positioning grooves 10711 and the two buckle grooves 10712 are distributed orthogonally in the outer side wall of the fixing base 1071. The buckles 1072 are opposite to the buckle grooves 10712. The buckle grooves 10712 are configured to allow the buckles 1072 to be elastically bent toward the buckle grooves 10712. The mounting base 42 is provided with engaging protrusions 421 fitting with the buckles 1072 and positioning protrusions 422 fitting with the positioning grooves 10711, The two positioning protrusions 422 and the two engaging protrusions 421 are distributed orthogonally at the bottom of the fixing base 1071. The engaging protrusions 421 are configured to be locked to the buckles 1072, so that the roller brush receptacle 40 can be detachably mounted to the tray 10. The positioning protrusions 422 are configured to be inserted and mounted into the positioning grooves 10711 to prevent a rotation of the roller brush receptacle 40 relative to the receptacle mounting portion 107 and facilitate the engagement of the engaging protrusions 421 to the buckles 1072 to prevent misaligned engagement.

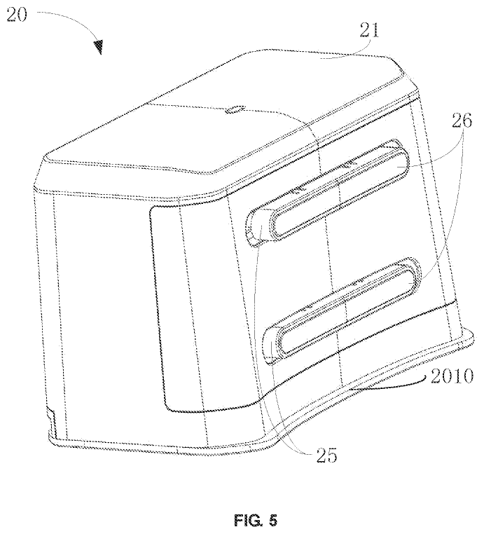

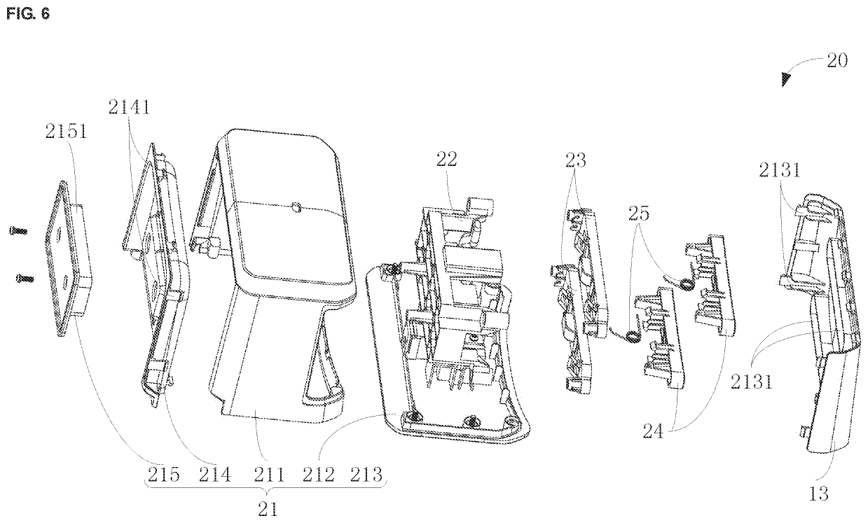

Referring to FIG. 5 in combination with FIG. 6, regarding the charging stand 20 described above, the charging stand 20 is configured to charge the cleaning robot. The charging stand 20 includes a housing 21, a mounting support 22, a fixed support 23, a movable support 24, an elastic member 25, and a charging terminal 26. The mounting support 22, the fixed support 23, the movable support 24, the elastic member 25, and the charging terminal 26 are all mounted in the housing 21. The mounting support 22 is mounted in the housing 21. The fixed support 23 is mounted to the mounting support 22. The movable support 24 is movably connected to the fixed support 23. The movable support 24 can reciprocate relative to the fixed support 23. The elastic member 25 elastically connects the fixed support 23 and the movable support 24. The elastic member 25 is configured to provide an elastic restoring force, so that there is an elastic restoring force between the fixed support 23 and the movable support 24. The charging terminal 26 is mounted to the movable support 24, and the charging terminal 26 is movable with the movable support 24.

In the charging stand 20 according to the embodiment of the present disclosure, the charging terminal 26 is mounted to the movable support 24, the movable support 24 is movably connected to the fixed support 23, and an elastic member 25 is arranged between the fixed support 23 and the movable support 24. In this way, while the cleaning robot is contacting and being charged by the charging terminal 26, the elastic member 25 produces cushioning and resilient effects, thereby avoiding damage of the cleaning robot and/or the charging stand 20 due to collision, to ensure the service life of the charging stand 20 with a simple structure and low cost.

It will be understood that the movable support 24 may be movably connected to the fixed support 23 in such a manner that the movable support is connected to be slidable in a forward and backward direction. The forward and backward direction is the same as a direction in which the cleaning robot moves on the charging stand 20. In this case, the fixed support 23 has a guide slot or guide rail along which the movable support 24 slides back and forth, Alternatively, the movable connection of the movable support 24 to the fixed support 23 may be a rotatable connection. The movable support 24 may be rotatable upward, downward, leftward, or rightward to provide a cushioning space for the charging terminal 26, wherein the upward, downward, leftward, and rightward directions are all defined on the basis of the forward and backward direction.

The housing 21 includes a main frame 211, a base 212, a first panel 213, a second panel 214, and a fixed panel 215.

The main frame 211 is in a substantially semi-enclosed structure. The base 212 is of a substantially plate shape. The main frame 211 is fixedly connected to the base 212 to form a “rectangular frame” shape. Here, the main frame 211 and the base 212 are fixed to each other by screw connection, in order to strengthen the connection between the main frame 211 and the base 212. Of course, the main frame 211 and the base 212 may be fixed to each other by other connection methods such as snap-fit connection.

Further, the first panel 213 and the second panel 214 are mounted on the front and rear sides of the main frame 211, respectively, and surround and form a relatively closed accommodating cavity together with the main frame 211 and the base 212. The accommodating cavity is configured to receive the fixed support 23, the movable support 24, the elastic member 25, and the charging terminal 26 described above. The first panel 213 is provided with an opening 2131. The opening 2131 extends through the first panel 213 in the forward and backward direction. The opening 2131 communicates with the accommodating cavity for allowing the charging terminal 26 to be retracted into or protruded from the accommodating cavity therethrough during contact charging. Here, in the state without contact charging, the movable support 24 is protruded from the opening 2131 under the action of the elastic member 25. During contact charging, the movable support 24 overcomes the elastic force of the elastic member 25 and is retracted into the opening 2131 under the action of an external force.

The first panel 213 and the second panel 214 are fixed to the main frame 211 by means of buckle connection, respectively, in order to facilitate the respective mounting of the first panel 213 and the second panel 214 to the main frame 211 and reduce the assembly time. Specifically, the first panel 213 is provided with a first buckling portion 2131, the second panel 214 is provided with a second buckling portion 2141, and the main frame 211 is provided with a first flange and a second flange matching the first buckling portion 2131 and the second buckling portion 2141, respectively. The first buckling portion 2131 is engaged with the first flange so that the first panel 213 is fixed to the main frame 211. The second buckling portion 2141 is engaged with the second flange so that the second panel 214 is fixed to the main frame 211. Of course, the first panel 213 and the second panel 214 may also be fixed to the main frame 211 by other connection methods such as screw connection.

The fixed panel 215 is mounted to a surface of the second panel 214 facing away from the first panel 213. The fixed panel 215 is provided with a wire winding portion 2151. The wire winding portion 2151 extends from a surface of the fixed panel 215 opposite to the second panel 214 toward the second panel 214. The wire winding portion 2151 is configured to allow a wire to be wound thereon. Here, the fixed panel 215 and the second panel 214 are fixed to each other by means of screw connection. Of course, in other embodiments, the fixed panel 215 and the second panel 214 may also be fixed to each other by other connection methods such as snap-fit connection.

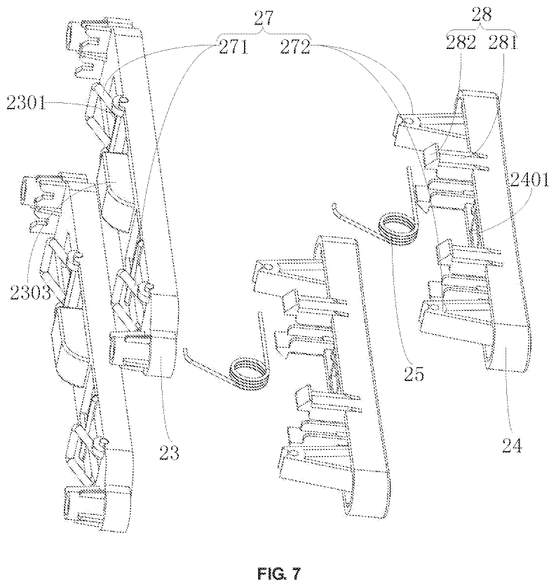

With also reference to FIG. 7, FIG. 7 is a partial structure view of the charging stand. The movable support 24 is rotatably connected to the fixed support 23 by means of a guide structure 27. The guide structure 27 is configured to guide a rotation of the movable support 24 in a preset direction to drive a movement of the charging terminal 26, Here, the preset direction may be an upward, downward, leftward, or rightward direction. For this reason, the opening 2131 has a corresponding movement space. Taking an upward rotation of the movable support 24 as an example, the opening 2131 provides a space for the upward rotation of the movable support 24 and the charging terminal 26 thereon. When the charging pole piece of the cleaning robot collides with the charging terminal 26, the charging terminal 26 will be rotated upwards and kept in contact with the charging pole piece while being retracted relative to the opening 2131. Taking a leftward rotation of the movable support 24 as an example, the opening 2131 provides a space for the leftward rotation of the movable support 24 and the charging terminal 26 thereon. When the charging pole piece of the cleaning robot collides with the charging terminal 26, the charging terminal 26 will be rotated leftward and kept in contact with the charging pole piece while being retracted relative to the opening 2131, Here, the guide structure 27 may consist of a partial structure of the fixed support 23 and a partial structure of the movable support 24, or may be a structure independent of the fixed support 23 and the movable support 24.

Specifically, for one charging terminal 26, the fixed support 23 has a first side surface and a second side surface opposite to each other. The first side surface is arranged to face the movable support 24. Both ends of the fixed support 23 are provided with connecting holes 2301 extending through the first side surface and the second side surface. The guide structure 27 includes two rotatable members 271 and two connectors 272. The two rotatable members 271 are both rotatably arranged on the second side surface, and are both located on the same side of the connecting holes 2301 to be rotatable toward either end of the fixed support, The two connectors 272 are fixed to respective ends of the movable support 24. Each of the connectors 272 has an end which extends through one of the connecting holes and to which one of the rotatable members 271 is rotatably connected. As shown in FIG. 7, the same structure as described above can be used for the other charging terminal 26.

The two rotatable members 271 on the fixed support 23 are rotatably connected to the two connectors 272 on the movable support 24, respectively. The two rotatable members 271 are rotatable toward either end of the fixed support 23 to guide the rotation of the movable support 24 toward one end of the fixed support 23, thereby achieving cushioning of the charging terminal 26.

Further, the charging terminal 26 is arranged in a long strip shape and extends in a left-to-right direction. In this regard, the movable support 24 can be rotated leftward or rightward under the action of the guide structure 27, and the charging terminal 26 thereon is movable leftward or rightward, because the charging terminal 26 is long enough in the left-to-right direction and the leftward or rightward movement will not affect its contact with the charging pole piece on the cleaning robot.

Further, the two connectors 272 are molded integrally with the movable support 24. In other words, the two connectors 272 constitute part of the movable support 24. In other embodiments, the connectors 272 are independent components which are mounted and fixed to the movable support 24 in other ways.

An engaging hole is provided in an end surface of one end of each connector 272. Each rotatable member 271 has a rotating shaft portion which is engaged in the engaging hole and rotatably connected in the engaging hole.

Further, in order to facilitate the insertion of the rotating shaft portion into the engaging hole, a guide slot is also provided in the end surface of one end of each connector 272. The guide slot communicates with the engaging hole. The guide slot has an opening larger than the diameter of the rotating shaft portion. The rotating shaft portion is inserted into the engaging hole through the guide slot.

The charging terminal 26 is an electrode sheet being of a long strip shape and has an annular insert portion. An insertion slot is provided in a side surface of the movable support 24 facing away from the fixed support 23. The annular insert portion is inserted and fixed in the insertion slot.

The movable support 24 is further provided with a limiting structure 28. The limiting structure 28 is arranged corresponding to the opening 2131 and is configured to restrict a movement of the movable support 24 in a direction away from the opening 2131 under the action of the elastic member 25, thereby preventing the movable support 24 from falling from the housing.

Specifically, the limiting structure 28 includes a fixing rod 281 and an abutting protrusion 282. The abutting protrusion 282 is fixed to one end of the fixing rod 281. The fixing rod 281 is fixed to the movable support 24 at its end away from the abutting protrusion 282. A convex ring extends inwardly from the peripheral edge of the opening 2131. The end of the fixing rod 281 away from the movable support 24 is moved through the opening 2131. The abutting protrusion 282 abuts against an end surface of the convex ring to restrict a movement of the movable support 24 in a direction away from the opening 2131 to avoid its falling from the opening 2131.

In this embodiment, the elastic member 25 is a torsion spring. One torsion arm of the elastic member 25 abuts against the fixed support 23, and the other torsion arm of the elastic member 25 abuts against the movable support 24, so that there is elastic restoring potential energy between the movable support 24 and the fixed support 23. It will be understood that the number of the elastic members 25 may be selected as actually required. The number of the elastic members 25 is not limited in the embodiments of the present disclosure. For example, two elastic members 25 are arranged between one movable support 24 and one fixed support 23.

The movable support 24 is provided with a first receiving groove 2401. The fixed support 23 is provided with a second receiving groove 2303. One torsion arm of the elastic member 25 is received in the first receiving groove 2401, and the other torsion arm of the elastic member 25 is received in the second receiving groove 2303. In this way, the elastic member 25 is firmly connected between the fixed support 23 and the movable support 24, and the elastic member 25 is prevented from being disengaged from the fixed support 23 and the movable support 24. In other embodiments, the elastic member 25 may be another elastic element having an elastic restoring force, such as a leaf spring, a compression spring, or the like.

In this embodiment, the charging stand 20 includes two fixed supports 23, two movable supports 24, and two charging terminals 26. The two movable supports 24 are movably connected to the two fixed supports 23, respectively. The two charging terminals 26 are mounted to side walls of the two movable supports 24 facing away from the fixed supports 23, respectively. Here, the first panel 213 is provided with two openings 2131, The two movable supports 24 are movably passed through the two openings 2131, respectively. The two charging terminals 26 are a positive electrode charging terminal and a negative electrode charging terminal, respectively.

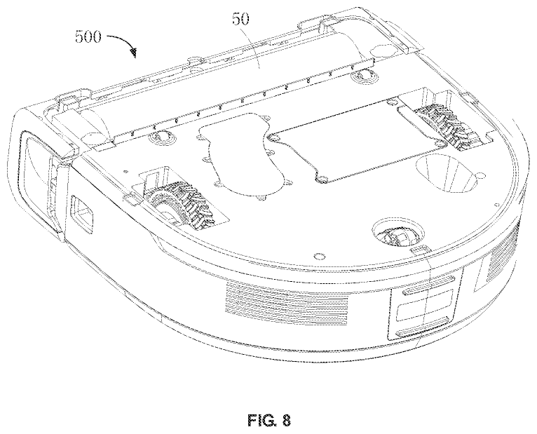

Referring to FIG. 8 in combination with FIG. 1, an embodiment of the present disclosure also provides a cleaning system. The cleaning system includes a docking station 100 and a cleaning robot 500. The docking station 100 has a specific structure as described with reference to the foregoing embodiment. The cleaning system of this embodiment involves all the technical solutions of the docking station of the foregoing embodiment and therefore also has all the advantageous effects achieved by the technical solutions of the foregoing embodiment, which will not be described in detail here. When the cleaning robot 500 is docked at the docking station 100, a roller brush 50 of the cleaning robot is at least partially located in the cleaning structure 101.

The above description is merely illustrative of the embodiments of the present disclosure and is not intended to limit the scope of the present disclosure. Any equivalent structural or equivalent process modifications made according to the description and drawings of the present disclosure, or direct or indirect applications of the present disclosure to other related technical fields are also encompassed in the scope of protection of the present disclosure.

What is claimed is:

1. A docking station, applicable to a cleaning robot to be docked, comprising:
a tray, comprising a cleaning structure, wherein the cleaning structure is configured for self-cleaning of a roller brush of the cleaning robot; and
a charging stand, detachably mounted to the tray.

2. The docking station according to claim 1, wherein the cleaning structure is a cleaning groove, the cleaning groove is configured to receive at least part of the roller brush, and the roller brush rotates in the cleaning groove so as to be self-cleaned.

3. The docking station according to claim 2, wherein the tray defines a first groove and a second groove, the cleaning groove is arranged in the first groove, and the second groove is located between the charging stand and the first groove and configured to support a part of the cleaning robot.

4. The docking station according to claim 3, wherein the tray further comprises first anti-slip patterns arranged on each of both sides of a bottom of the first groove and second anti-slip patterns arranged on each of both sides of a bottom of the second groove, the cleaning groove is located between two first anti-slip patterns, and the first anti-slip pattern and the second anti-slip pattern on a same side are arranged opposite to each other.

5. The docking station according to claim 3, wherein the tray further comprises a connecting wall formed between the first groove and the second groove, the connecting wall defines first inclined surfaces located on both sides of a side surface of the first groove, and the first inclined surfaces are inclined upwardly in a direction from the first groove toward the second groove.

6. The docking station according to claim 5, wherein each of the first inclined surfaces is located between the first anti-slip pattern and the second anti-slip pattern on the same side.

7. The docking station according to claim 3, wherein the first groove has an outer wall away from the second groove, and the outer wall has an outer side surface inclined upwardly in a direction from the first groove toward the second groove.

8. The docking station according to claim 1, wherein the tray further comprises a socket portion, and the charging stand further comprises an insert portion, wherein the insert portion is inserted into the socket portion.

9. The docking station according to claim 8, wherein at least two locking portions are provided at an edge of the socket portion dose to the cleaning structure, and the insert portion has an edge provided with a flange portion, wherein the at least two locking portions are locked to the flange portion.

10. The docking station according to claim 1, further comprising a roller brush receptacle, wherein the roller brush receptacle comprises a cylindrical body and a mounting base, wherein the cylindrical body has one end connected to the mounting base, and the other end configured for the roller brush of the cleaning robot to be inserted, and
the tray further comprises a mounting stand, wherein the mounting base is detachably mounted to the mounting stand.

11. The docking station according to claim 10, wherein the mounting stand comprises a fixing base and a buckle, the fixing base defines a positioning groove and a buckle groove, the buckle is opposite to the buckle groove, and the buckle groove is configured to allow the buckle to be elastically bent toward the buckle groove, and
the mounting base comprises an engaging protrusion and a positioning protrusion, the engaging protrusion is configured to be locked to the buckle, and the positioning protrusion is configured to be mounted into the positioning groove in a manner of insertion.

12. The docking station according to claim 1, wherein the charging stand comprises:
a housing;
a fixed support, fixed in the housing;
a movable support, movably connected to the fixed support;
a charging terminal, mounted to the movable support and arranged to protrude from a side surface of the housing; and
an elastic member, elastically abutting between the fixed support and the movable support.

13. The docking station according to claim 12, wherein the movable support is rotatably connected to the fixed support by means of a guide structure, and the guide structure is configured to guide the movable support to rotate in a preset direction, so as to drive the charging terminal to move.

14. The docking station according to claim 12, wherein the fixed support has a first side surface and a second side surface arranged opposite to each other, the first side surface is arranged toward the movable support, and both ends of the fixed support define connecting holes extending through the first side surface and the second side surface, and
the guide structure comprises two rotatable members and two connectors, wherein the two rotatable members are both rotatably arranged on the second side surface and are located on a same side of two connecting holes to be rotatable toward either end of the fixed support; and the two connectors are fixed to respective ends of the movable support, and each of the connectors has an end extending through one of the connecting holes and rotatably connected to one of the rotatable members.

15. A cleaning system, comprising a cleaning robot and the docking station according to claim 1, wherein the roller brush of the cleaning robot is at least partially located in the cleaning structure, when the cleaning robot is docked at the docking station.

16. A docking station, applicable to a cleaning robot to be docked, comprising:
a tray, defining a first groove, and comprising a plurality of first raised features arranged on a bottom of the first groove and configured to support a cleaning element of the cleaning robot; and
a charging stand, detachably mounted to the tray,

17. The docking station according to the claim 16, wherein the plurality of first raised features comprise a first left part arranged on the left side of the bottom of the first groove and a first right part arranged on the right side of the bottom of the first groove.

18. The docking station according to the claim 17, wherein the tray defines a second groove located between the charging stand and the first groove and configured to support a part of the cleaning robot.

19. The docking station according to the claim 18, wherein the tray further comprises a plurality of second raised features arranged on a bottom of the second groove; and
the plurality of second raised features comprise a second left part arranged on the left side of the bottom of the second groove and a second right part arranged on the right side of the bottom of the second groove;
wherein the first left part is corresponding to the second left part, and the first right part is corresponding to the second right part.

20. A cleaning system, comprising a cleaning robot and a docking station according to claim 16, wherein the cleaning element of the cleaning robot is at least partially located in the first groove and supported by the plurality of first raised features, when the cleaning robot is docked at the docking station.
